(19) United States
(12) Patent Application Publication
(10) Pub. No.: US 2021/0025854 A1
(43) Pub. Date: Jan. 28, 2021

(54) SPARK ACOUSTIC EMISSION SIMULATION

(71) Applicant: BOARD OF REGENTS, THE UNIVERSITY OF TEXAS SYSTEM, Austin, TX (US)

(72) Inventors: Salvatore SALAMONE, Austin, TX (US); Arvin EBRAHIMKHANLOU, Austin, TX (US)

(21) Appl. No.: 16/980,673

(22) PCT Filed: Mar. 14, 2019
(86) PCT No.: PCT/US2019/022210

§ 371 Date: Sep. 14, 2020

Related U.S. Application Data
(60) Provisional application No. 62/642,947, filed on Mar. 14, 2018.

(51) Int. Cl. G01N 29/34; G01N 29/04

(52) U.S. Cl. CPC G01N 29/34; G01N 29/043

(57) ABSTRACT

Some aspects of the present disclosure relate to spark acoustic emission simulation. In some embodiments, one or more electrical spark generating components generate sparks at a metallic portion of a structure to stimulate the emission of acoustic and/or ultrasonic waves in the structure. One or more contact or non-contact sensors sense the emitted waves in the structure. One or more processors determine, based on signals corresponding to the emitted waves as sensed by the sensors, physical characteristics of the structure.

### CROSS-REFERENCE TO RELATED APPLICATION

This application claims priority to and the benefit of U.S. Provisional Patent Application No. 62/642,947, filed Mar. 14, 2018 and entitled “Spark Acoustic Emission Simulation”, the entire contents of which is hereby incorporated by reference herein.

### BACKGROUND

Acoustic emission (AE) generates transient stochastic waves in structures. These waves have been used in nondestructive testing (NDT) of structures. Development of many data driven algorithms for AE requires simulating AE signals in an automatic way. However, such simulations are challenging because the emitted waves need to be transient, stochastic, and non-repeatable by nature to be a realistic representative of actual AE signals. A traditional manual technique named “Hsu-Nielsen pencil lead break test” (PLB) is conventionally used to simulate AE (Hsu 1977). However, this technique is not controllable. Furthermore, existing devices cannot simulate the stochastic nature of acoustic emission (Dunegan H. L.). It is with respect to these and other considerations that the various embodiments described below are presented.

### SUMMARY

In one aspect, the present disclosure relates to a system which, in one embodiment, includes one or more electrical spark generating components, configured to generate one or more sparks at a metallic portion of a structure, such as to stimulate the emission of at least one of acoustic and ultrasonic waves in the structure. One or more contact or non-contact sensors can be configured to sense the emitted waves in the structure. The system can also include one or more processors configured to, based on signals corresponding to the emitted waves as sensed by the sensors, determine physical characteristics of the structure.

In some implementations, determining the physical characteristics of the structure can include determining if the structure contains one or more defects.

Alternatively or additionally, the system can include a controller coupled to the one or more spark generating components and configured to control times at which the sparks can be generated.

Alternatively or additionally, the one or more electrical spark generating components can be separated from contact with the structure.

Alternatively or additionally, the one or more spark generating components can include electrodes configured to discharge electricity to the structure to generate the one or more sparks.

Alternatively or additionally, the one or more processors can be configured to, based on the signals corresponding to the sensed emitted waves, determine the locations of the one or more defects.

Alternatively or additionally, the one or more defects can include corrosion or cracking.

Alternatively or additionally, the electrical spark generating components can be coupled to circuitry configured to select respective voltage and current for the one or more sparks.

Alternatively or additionally, the circuitry can be further configured such that the one or more sparks can be pulsed with a high voltage and low current.

Alternatively or additionally, the one or more electrical spark generating components can be configured to generate a plurality of sparks simultaneously or separated by a selected time delay.

Alternatively or additionally, the one or more electrical spark generating components can be placed at different locations from one another at the structure.

Alternatively or additionally, the selected time delay can be between about 0 and 250 microseconds.

Alternatively or additionally, the selected time delay can be about 50 microseconds.

Alternatively or additionally, the selected time delay can be about 250 microseconds.

Alternatively or additionally, the structure can be metallic.

Alternatively or additionally, the structure can include a metallic plate at which the one or more sparks can be generated.

Alternatively or additionally, the structure can include a metallic plate having an edge. Optionally, one or more spark generating components can be placed proximate the edge and can be configured to excite guided ultrasonic waves.

Alternatively or additionally the one or more sparks can be generated such as to simulate a symmetric guided ultrasonic wave mode.

Alternatively or additionally one or more electrical spark generators can be provided at symmetric locations on two opposing sides of the structure.

Alternatively or additionally, one or more electrical spark generators can be configured to generate the one or more sparks. Optionally the one or more sparks can simulate an antisymmetric guided ultrasonic wave mode.

Alternatively or additionally, the one or more processors can be configured to localize acoustic emission sources using one or more sparse reconstruction functions.

Alternatively or additionally, the one or more electrical spark generating components and the one or more sensors can be provided in a contained portable device. Optionally, the electrical spark generating components and sensors do not contact the structure when in use.

Alternatively or additionally, the portable device can include a portable power source for the one or more electrical spark generating components and the one or more sensors.

Alternatively or additionally, the portable power source can include one or more batteries.

Alternatively or additionally the contained portable device can be configured to be handheld.

Alternatively or additionally, the contained portable device can be configured to perform nondestructive testing for a structure.

In another aspect, the present disclosure relates to a method which, in one embodiment, includes generating, at a structure, one or more electrical sparks configured to stimulate the emission of at least one of acoustic and ultrasonic waves in the structure. The method can also include using one or more sensors, sensing the emitted waves in the structure. The method can also include determining, based on signals corresponding to the emitted waves as sensed by the sensors, one or more physical characteristics of the structure.

Alternatively or additionally, determining the one or more physical characteristics of the structure can include determining whether the structure contains one or more defects.

Alternatively or additionally, the method can also include determining, based on the signals, the location of the one or more defects.

Alternatively or additionally, the one or more defects can comprise corrosion or cracking.

Alternatively or additionally, the one or more sparks can have respective voltage and current selected using a controller.

Alternatively or additionally, the one or more sparks can be pulsed and have a high voltage and low current.

Alternatively or additionally, the one or more sparks can include a plurality of sparks generated simultaneously or separated by a selected time delay.

Alternatively or additionally, the one or more sparks can be generated by a respective plurality of electrical spark generators placed at different locations from one another at the structure.

Alternatively or additionally, the one or more sensors can include a plurality of contact or non-contact acoustic emission sensors placed at different locations from one another at the structure.

Alternatively or additionally, the selected time delay can be between about 0 and 250 microseconds.

Alternatively or additionally, the selected time delay can be about 50 microseconds.

Alternatively or additionally, the selected time delay can be about 250 microseconds.

Alternatively or additionally, the structure can be metallic.

Alternatively or additionally, the structure can be a metallic plate or pipe.

Alternatively or additionally, the structure can include a metallic plate disposed thereon at which the sparks can be generated.

Alternatively or additionally, the structure can include a metallic plate having an edge. Optionally, the method can include stimulating acoustic emission on the edge of the plate to excite guided ultrasonic waves.

Alternatively or additionally, the one or more sparks can be generated such as to simulate a symmetric guided ultrasonic wave mode.

Alternatively or additionally, simulating the symmetric guided ultrasonic wave mode can include providing one or more electrical spark generators at symmetric locations on two opposing sides of the structure.

Alternatively or additionally, the one or more sparks can be generated such as to simulate an antisymmetric guided ultrasonic wave mode.

Alternatively or additionally, the method can also include localizing acoustic emission sources using one or more sparse reconstruction functions.

In some aspects, the present disclosure relates to simulating AE. In some embodiments, a spark acoustic emission (AE) simulator uses electric arcs to simulate AE in a controllable but stochastic way. A high-voltage, very low-current electric pulse creates a spark between the tip of an electrode and a grounded metallic structure. The impulse excites acoustic and ultrasonic waves in the structures. Such waves, like any AE wave, can be measured using different sensors, including contact sensors, non-contact (e.g., air-coupled) sensors, and laser Doppler vibrometers (see, e.g., FIG. 1). Two or more of the same device can be placed at different locations on a structure to simulate acoustic emission either simultaneously or with a controllable time difference. Also, simultaneous stimulations at different faces of a structure can be used to excite different acoustic and ultrasonic modes. In plate-like and thin-walled structures such as pipes, some embodiments can excite guided ultrasonic waves. Multiple spark generating devices can be used on the two faces of the structure to simulate symmetric guided ultrasonic waves. In addition, a controlled phase shift between the firing time of each spark can be used to adjust the relative amplitude of the excited symmetric and antisymmetric guided ultrasonic modes. Moreover, in plate-like structures, disclosed devices can also generate AE on the edges of the plate to excite symmetric guided ultrasonic waves.

Among other advantages and benefits provided, various embodiments described herein can provide nondestructive testing (NDT) applications. The broadband excitation generated by some disclosed embodiments described herein makes them a low-cost alternative for an impulse laser used in laser ultrasonic testing. In addition, the stochastic characteristics of the simulated signals make them suitable for training stochastic signals processing and machine learning algorithms that need realistic AE signals, such as deep learning and sparse reconstruction.

Other aspects and features according to the present disclosure will become apparent to those of ordinary skill in the art, upon reviewing the following detailed description in conjunction with the accompanying figures.

### BRIEF DESCRIPTION OF THE DRAWINGS

Reference will now be made to the accompanying drawings, which are not necessarily drawn to scale.

FIG. 1 shows a diagram of a spark acoustic emission system according to one embodiment.

FIG. 2 shows components of a spark acoustic emission device, wherein FIG. 2A shows a controller and transformer and FIG. 2B shows an electrode.

FIG. 3 is a schematic diagram of a test plate used in the simulation of acoustic emission according to one embodiment.

FIG. 4 shows an experimental setup for simulation of acoustic emission in accordance with one embodiment, which includes an electrode, AE sensor, and data acquisition system.

FIG. 5 shows signals from simulations using spark AE (FIG. 5A) according to one or more embodiments, in comparison with signals from simulations using a pencil lead break (PLB) test (FIG. 5B).

FIG. 6 shows a continuous wavelet transform of the simulated AE signals using spark AE (FIG. 6A), in comparison with a continuous wavelet transform of the signals from the pencil lead break test (FIG. 6B).

FIG. 7 shows a Fourier transform of the simulated AE signals using spark AE (FIG. 7A), in comparison with a Fourier transform of the signals from the PLB test (FIG. 7B).

FIG. 8 shows an embodiment of a spark acoustic system according to another embodiment.

FIG. 9A shows a signal recorded by the sensor from stimulated acoustic emission in the system shown in FIG. 8; FIG. 9B shows the same signal fully transformed in the frequency domain, and FIG. 9C shows a continuous wavelet transform of the signal.

FIG. 10A shows the wave signal from a sensor in a spark acoustic emission implementation, and

FIG. 10B shows the wave signal corresponding to a pencil lead break test.

FIGS. 11A and 11B show the results of continuous wavelet transforms on the signals in FIG. 10A and FIG. 10B, respectively.

FIGS. 12A and 12B show the respective results of Fourier transforms (FFT) on the signals in FIG. 10A and FIG. 10B in the frequency domain.

FIG. 13 shows an embodiment for simulating multiple acoustic emission events.

FIG. 14A shows the timing of the trigger signals (excitation signals) for the two sparks used in the embodiment corresponding to FIG. 13, and FIG. 14B shows the recorded acoustic emission signal for two of the sparks.

FIGS. 15A and 15B show an embodiment of a spark test on both sides of a plate, but using a sensor on only one side of the plate, wherein FIG. 15A shows two electrodes placed at the same relative location on opposing sides of an aluminum plate and FIG. 15B is an enlarged view of the plate and electrodes on both sides of the plate.

FIG. 16A shows recorded signals for an implementation in which a spark fired only on the side of the plate with the sensor (with reference to the embodiment of FIGS. 15A and 15B); FIG. 16B shows recorded signals for an implementation in which a spark was fired only at the opposite side of the plate from the side having the sensor; and FIG. 16C shows recorded signals for an implementation in which sparks were fired at both sides at the same time.

FIG. 17A shows a Fourier transform of the signal from FIG. 16A, and FIG. 17B shows a Fourier transform of the signal from FIG. 16C.

FIG. 18A shows a continuous wavelet transform of the signal in FIG. 16A (spark fired only on side of the plate with the sensor) and FIG. 18B shows a continuous wavelet transform of the signal in FIG. 16B (sparks simultaneously fired on both sides of plate).

FIGS. 19A and 19B show an embodiment of a system for simulating a symmetric Lamb wave mode, wherein in FIG. 19A a spark was applied at the edge of a plate, and compared to a PLB (FIG. 19B) at the edge of the plate.

FIG. 20A and FIG. 20B show the resulting waveform signals corresponding to FIG. 19A and FIG. 19B, respectively.

FIGS. 21A, 21B, and 21C show circuitry and electronic and electrical components for acoustic emission simulation embodiments that utilize two sparks.

FIGS. 22A, 22B, and 22C show a system for spark acoustic emission simulation in accordance with another embodiment.

FIG. 23A shows the spark triggering signals sent to transformers for generating the sparks to stimulate acoustic emission in the system of FIG. 22, and FIG. 23B shows the recorded acoustic emission signal, which illustrates an approximately 43.8 microsecond difference between the first two arrivals.

FIG. 24 illustrates, with reference to the embodiment of FIG. 22, results of the use of a localization algorithm for locating the source of the sparks.

FIG. 25 shows a system for active ultrasonic testing simulation in accordance with one embodiment.

FIGS. 26A, 26B, and 26C show various signals relating to localization of the magnets in the embodiment of FIG. 25.

FIG. 27 shows a reconstructed image with representations of the location of damage in a structure.

FIGS. 28A and 28B shows a system for spark acoustic emission simulation in accordance with another embodiment, wherein two sparks are generated at the same location with a time delay between each firing.

FIGS. 29A, 29B, 29C, and 29D correspond to actual acoustic emission signals with reference to implementations of the system in FIG. 28.

### DETAILED DESCRIPTION

Some aspects of the present disclosure relate to spark acoustic emission simulation. Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

Some references, which may include patents, patent applications, and various publications, are cited in a reference list and discussed in the disclosure provided herein. The citation and/or discussion of such references is provided merely to clarify the description of the present disclosure and is not an admission that any such reference is “prior art” to any aspects of the present disclosure described herein. All references cited and discussed in this specification are incorporated herein by reference in their entireties and to the same extent as if each reference was individually incorporated by reference.

The following description provides a discussion of certain aspects of the present disclosure in accordance with example embodiments. In accordance with some aspects, and in some embodiments, a disclosed device is capable of controlling the time at which acoustic emission activity is simulated. This feature allows for two or more of the same device to be placed at different locations on a structure to simulate acoustic emission activities either simultaneously or with a controllable time difference. Also, simultaneous simulations at different faces of a structure can be used to excite different acoustic and ultrasonic modes, including pure excitation of the symmetric Lamb wave mode in plate-like structures and pipes. In this way, the device may be used to populate a dictionary of AE signals to train, validate, and test a sparse reconstruction algorithm for localizing multiple AE sources. In addition, the simulated activities have a stochastic nature which is an intrinsic characteristic of any acoustic emission. This feature is central to the data used for training any data driven algorithm based on AE, including deep learning. This stochastic feature allows the deep learning algorithm to generalize over unseen data.

In some embodiments, device(s) generate sparks at a small stand-off distance that makes non-contact excitation of AE and ultrasonic waves possible. In addition, the excitations are broadband that essentially make them a suitable low-cost alternative to an impulse laser used in laser ultrasonic testing; such types of lasers require specific safety precautions, such as personnel training, use of eye wares and gloves, and safety barriers to prevent the laser beam from escaping the room in which the laser is being used. In contrast, embodiments of the present disclosure can use impulses that are safe because of their low current, and since only low current is required for the sparks, certain embodiments can operate by battery power. The non-contact and battery-operated features allow for configuring the device as a handheld NDT device. Among many other practical, advantageous and beneficial uses, a device in accordance with some embodiments of the present disclosure can be used for the following applications: as an alternative for laser ultrasonic testing used in many applications, including production lines and in a non-contact active tomography imaging method mounted on a robotic head, where such an imaging method may use non-contact ultrasonic probes such as air-coupled or laser Doppler vibrometer sensors; as a method of simulating pure symmetric Lamb wave modes at and away from the edges of plate-like structures, or controlling the relative amplitude of the symmetric and antisymmetric modes; as a battery-operated, hand-held device for nondestructive testing; and, as for a calibration method for AE testing. Some implementations can use spark generation device(s) as actuator(s) in active ultrasonic testing. In ultrasonic testing, a set of actuators can generate ultrasonic waves. In some embodiments, a spark device can be used as a non-contact and movable actuator, which can be moved to different locations by a robot.

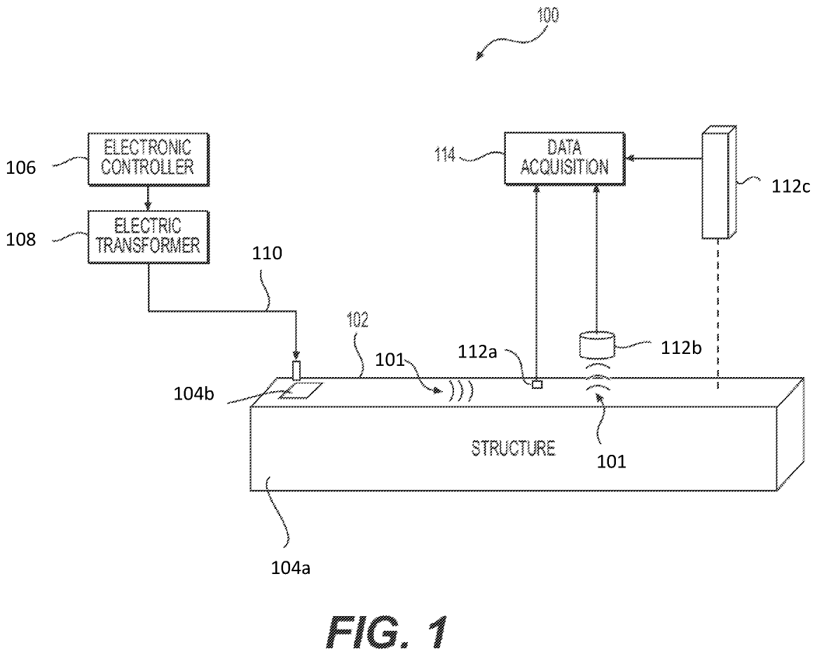

FIG. 1 shows a diagram of a spark acoustic emission system 100 in accordance with an embodiment of the present disclosure. Acoustic and ultrasonic waves 101 are excited by a sudden discharge of an electric spark 102 to a metallic host. The stochastic nature of electric discharge simulates the stochastic nature of any acoustic emission activity. For metallic structures, the host is the structure itself 104a. For other structures, the host is a thin metallic plate 104b attached to the surface of the structures. The time of the acoustic emission excitation is electronically controlled by a computer 106 (which may hereinafter also be referred to in this context as a “controller”). Controller hardware 106 can convert a digital command to a low voltage pulse. A transformer 108 converts the low voltage pulse to a high voltage but very low current, output pulse 110. The high voltage pulse 110 generates the spark 102 that excites mechanical waves in the structure.

### Example Implementations and Results

The following description provides a further discussion of certain aspects and embodiments of the present disclosure, and the discussion of some example implementations also refers to corresponding results which includes experimental data. Experimental data presented herein is intended for the purposes of illustration and should not be construed as limiting the scope of the present disclosure in any way or excluding any alternative or additional embodiments.

### Example 1

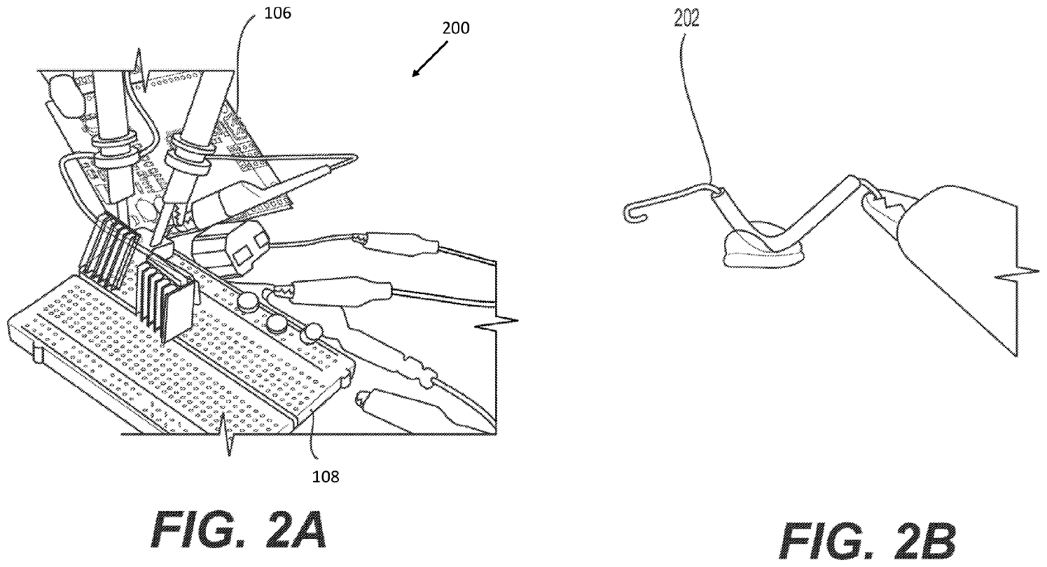

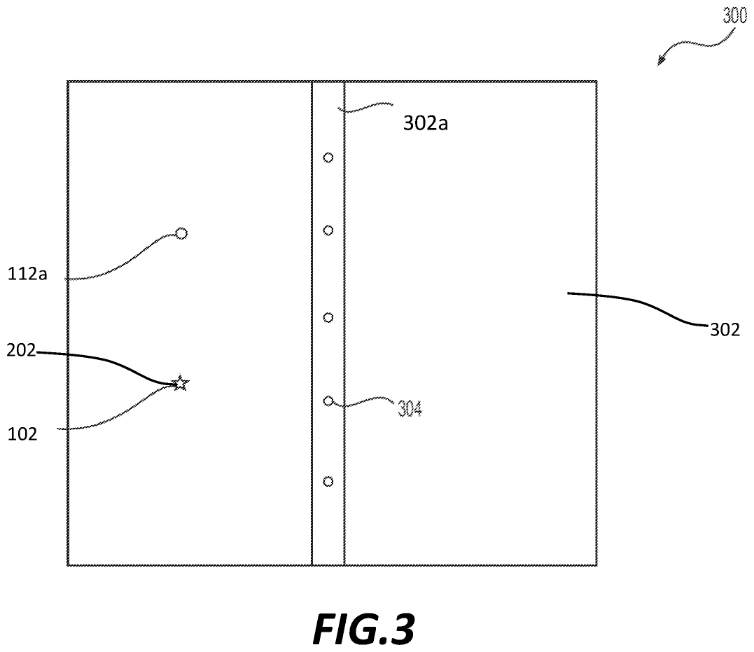

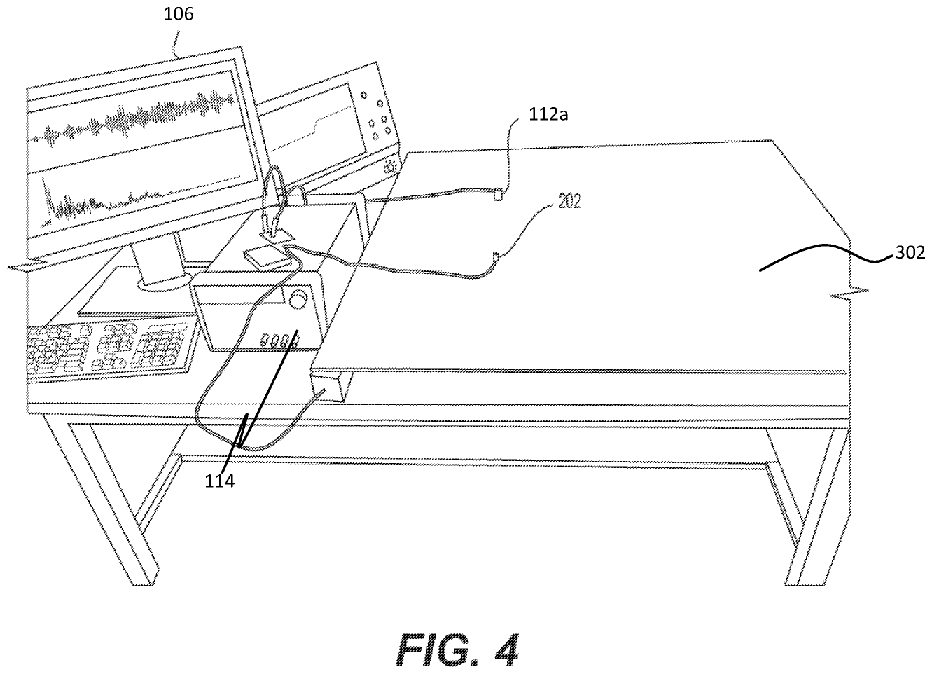

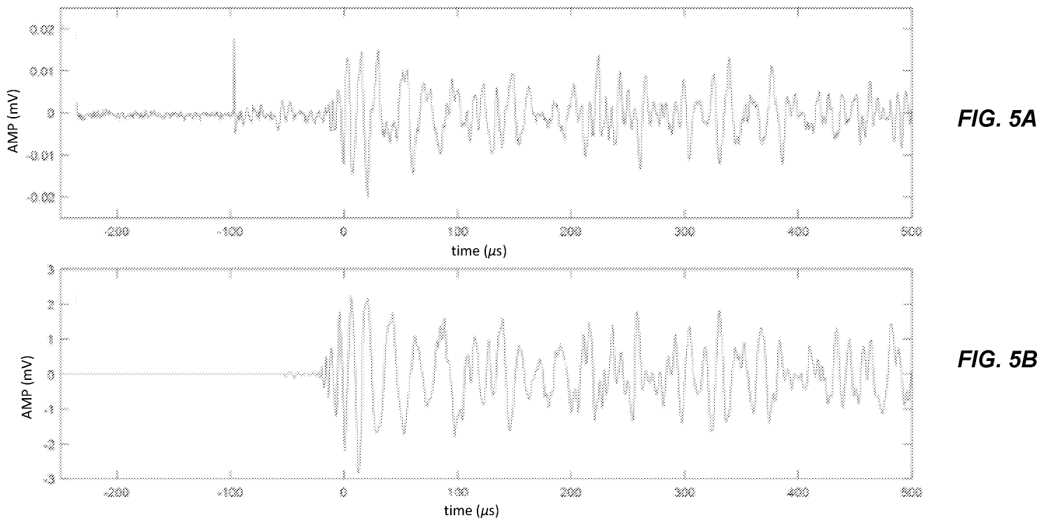

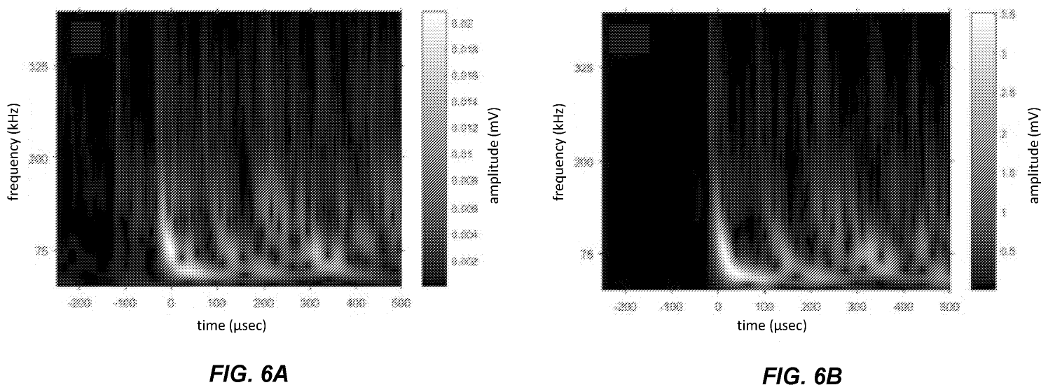

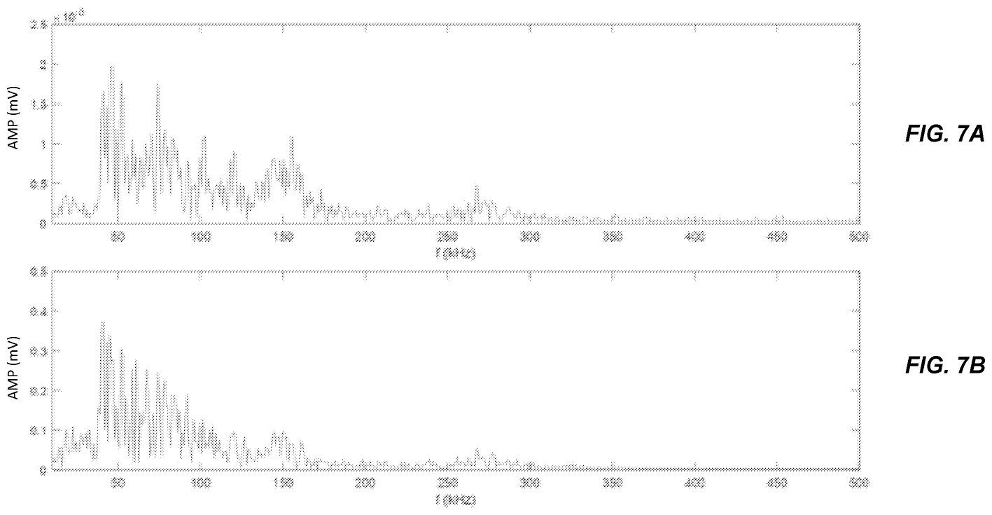

FIG. 2 shows an embodiment of a spark acoustic emission device 200 according to the present disclosure, wherein FIG. 2A shows a controller 106 and transformer 108 and FIG. 2B shows an electrode 202. FIG. 3 is a schematic diagram 300 of a test plate 302 used in the simulation of AE. FIG. 4 shows the experimental setup including the electrode 202, AE sensor 112a, and a data acquisition system 114. FIG. 5 compares the signals simulated with the spark AE device 200 (FIG. 5A) and a Hsu-Nielsen PLB test (FIG. 5B). FIGS. 6 and 7 compare the continuous wavelet and the Fourier transforms of the two signals, wherein FIG. 6 shows a continuous wavelet transform of the simulated AE signals with the spark AE device 200 (see FIG. 6A) and the PLB (FIG. 6B), and FIG. 7 shows a Fourier transform of the simulated AE signals with the spark AE device 200 (see FIG. 7A) and the PLB (FIG. 7B).

Experimental Setup

The configuration used in this example implementation was used to simulate AE on an aluminum plate 302 (FIG. 3) with a stiffener 302a in the middle. The plate 302 was made of 6061-T6 aluminum alloy with the dimensions of 36″×36″×⅛″ (see Table 1). The stiffener 302a was a one-inch-wide aluminum strip of the same material and thickness fastened to the back of the plate 302 with five ¼″ rivets 304. To simulate AE signals with the spark AE device 200, the electrode 202 of the device 200 was affixed to the plate 302 at the coordinates of (24″, 10″). The tip of the electrode 202 was place at a stand-off distance of approximately 1 mm ( 3/64″). In order to compare the simulated AE signals of the prototype device 200 with the traditional Hsu-Nielsen (Hsu 1977) pencil lead break (PLB) tests, five PLB tests were performed on the specimen at the same location that the tip of the electrode 202 was located. Specifically, a 0.3 mm mechanical pencil with 2H leads was placed at a 45-degree angle with respect to the plate 302, and its 3 mm-protruded lead was broken.

Now also referring to FIG. 4, to collect the simulated AE signals, an R15a AE sensor 112a (Physical Acoustics Corporation) was attached to the plate 302 at the coordinates of (24″, 14″) with hot glue. A data acquisition (DAQ) system 114 (Mistras Micro Express) digitized the AE signals after 40 dB amplification (Physical Acoustics 2/4/6 preamplifier). The sampling rate was 2 MHz, and the low pass and high pass analog filters of the DAQ system 114 were respectively set at 1 kHz and 1000 kHz. AE signals were post-processed in MATLAB. Processing activities such as post-processing activities including signal analysis, transformations, reconstructions, etc. to identify defects or perform image reconstructions associated with wave emissions in a structure may be referred to generally herein as being performed using a “processor” or “one or more processors”. The processor(s) may include or be operatively coupled to one or more of the above-mentioned components such as the controller 106, acoustic sensor(s) 112, transformer 108, DAQ 114, MATLAB and/or other software. Processor(s) as referred to herein may be programmable computer processors capable of executing computer-readable instructions.

TABLE 1
Properties of the tested plate

| Properties | Value | |
|---|---|---|
| Material | Aluminum alloy 6061-T6 | |
| Dimension | 91.4 × 91.4 × 0.318 | [cm] |
| Module of elasticity | 69 | [GPa] |
| Poisson's ratio | 0.33 | |
| Density | 2700 | [Kg/m³] |

Preliminary Results

FIG. 5 compares the signals simulated with the spark AE device 200 (FIG. 5A) and a Hsu-Nielsen PLB test (FIG. 5B). As can be seen, the two signals have very similar patterns in the time domain. In particular, the A₀ Lamb wave mode follows an almost synchronous vibration pattern in the two signals. The main difference between the two signals is in the amplitudes that could be later adjusted by using a higher voltage input to generate the sparks 102. In addition, in the signal simulated with the spark AE device 200 (FIG. 5A), a spike is observed that seems to be due to the electro-mechanical coupling between the AE sensor 112a and the structure. FIGS. 6 and 7 show comparisons of continuous wavelet and the Fourier transforms of the two signals, respectively. As can be seen, except for the amplitude, the results are very similar. Specifically, FIG. 6 shows a continuous wavelet transform of the simulated AE signals with the spark AE device 200 (FIG. 6A) and the PLB (FIG. 6B). FIG. 7 shows a Fourier transform of the simulated AE signals with the spark AE device 200 (FIG. 7A) and the PLB (FIG. 7B).

### Example 2

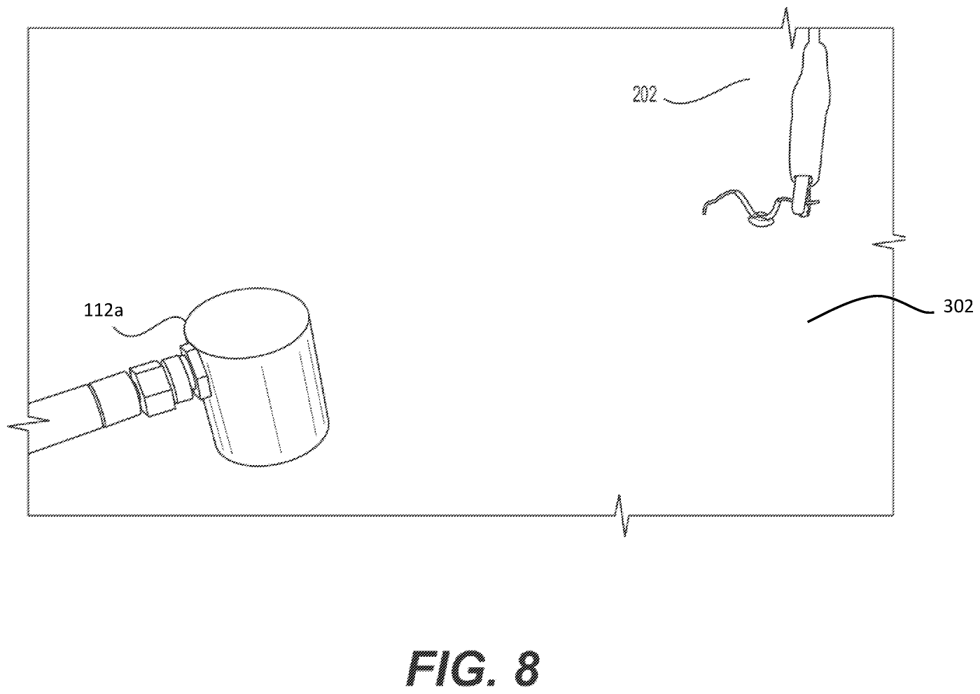

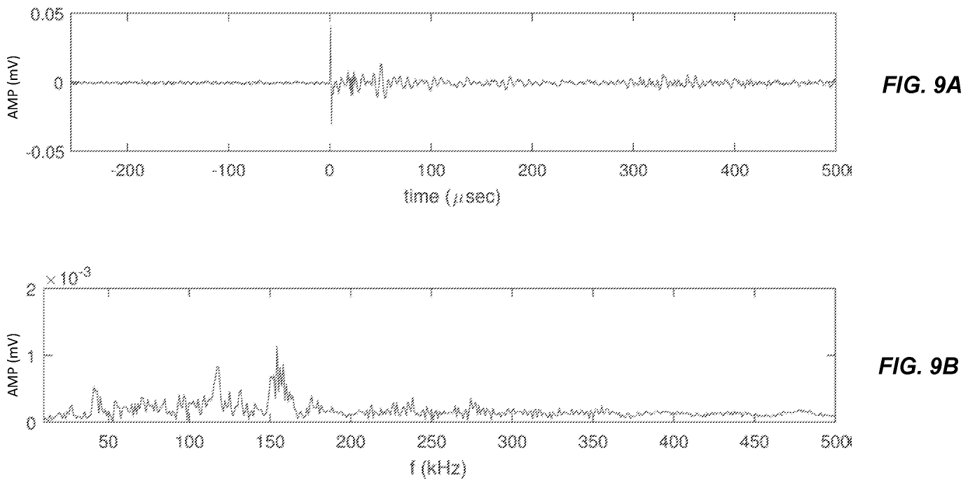

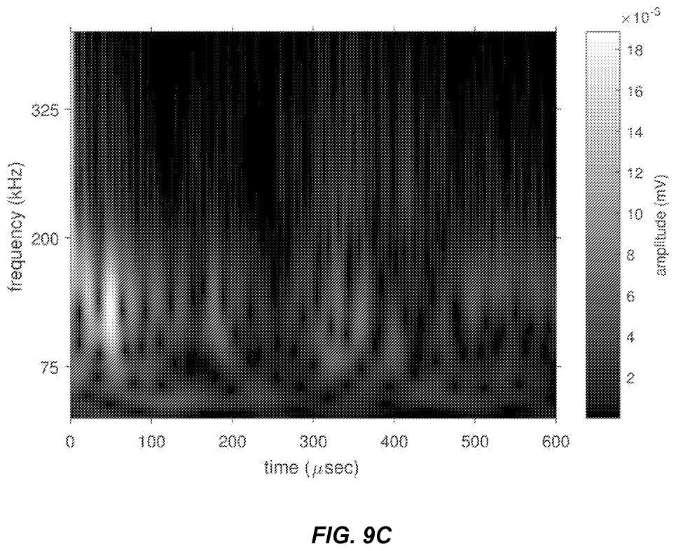

FIG. 8 shows an embodiment of a spark acoustic emission system 100 with a sensor 112a, spark generator (electrode) 202, and metal plate 302. An acoustic emission sensor 112a is shown at the bottom left, and a spark generator 202 is shown at the top right, each of them placed at the aluminum plate 302. FIG. 9A shows the signal recorded by the sensor 112a, from the stimulated acoustic emission in the aluminum plate 302. FIG. 9B shows the same signal fully transformed in the frequency domain, and FIG. 9C shows a continuous wavelet transform of the signal.

### Example 3

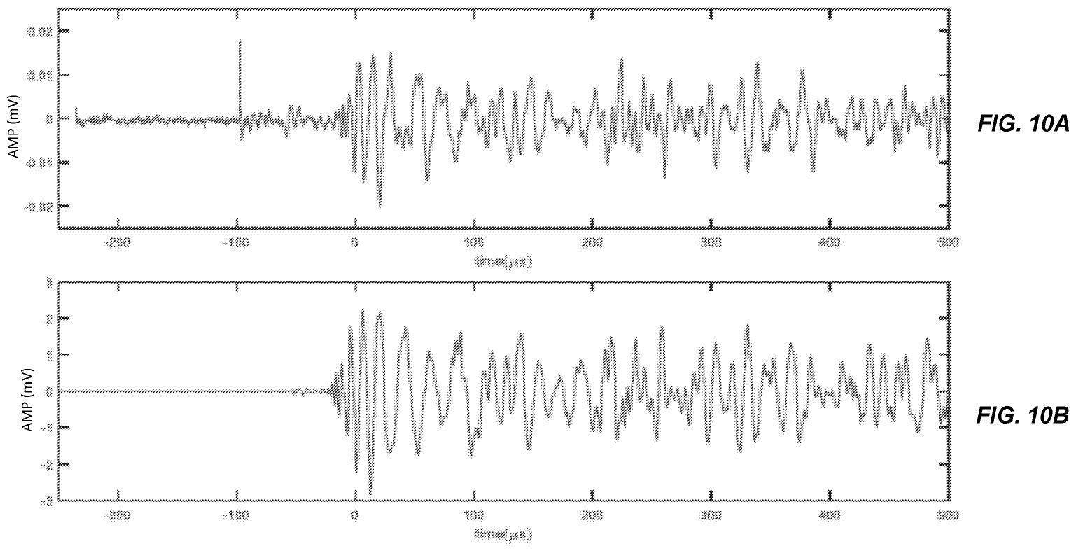

FIGS. 10-12 show wave signals for a spark acoustic emission implementation in accordance with one embodiment compared to signals for a conventional PLB test. As mentioned previously, the pencil lead break (PLB) test is a simple, mechanical and standard way to stimulate acoustic emission. In the PLB test for this example, the lead of a mechanical pencil is extruded about 3 millimeters and broken on the select surface of the structure to stimulate acoustic emission.

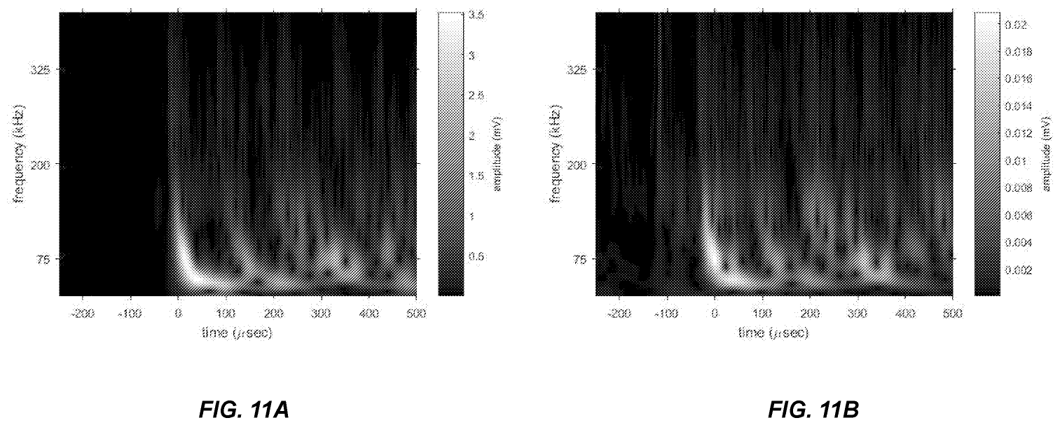

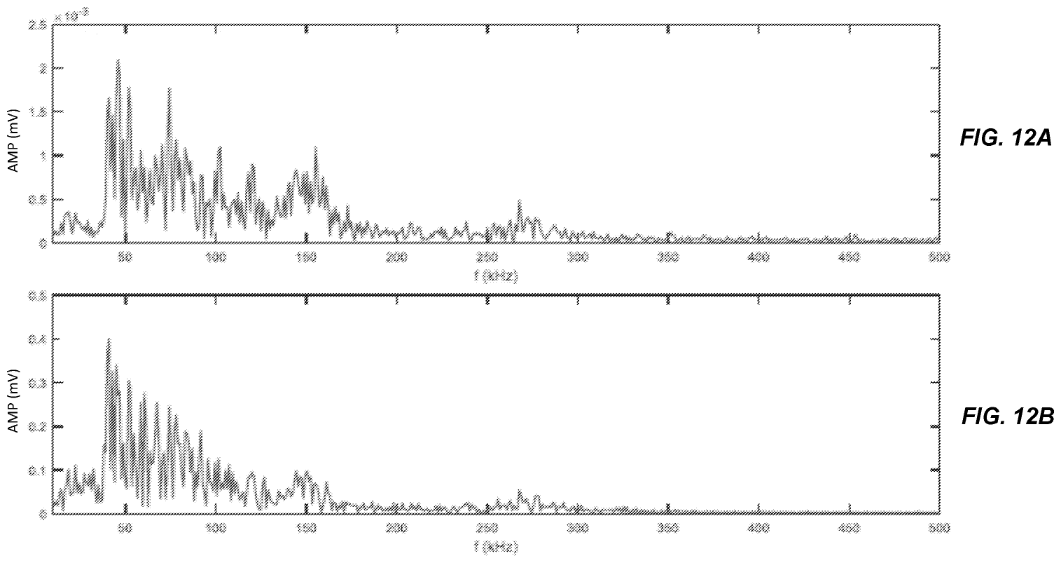

FIG. 10A shows the wave signal from a sensor in the spark acoustic emission implementation, and FIG. 10B shows the wave signal corresponding to the PLB test. As can be seen, the waves are comparable between the two approaches. There are a few noticeable differences between the signals, however. As shown in FIG. 10A, there is a sharp spike (see signal at time—100 microseconds) occurring before the signal of the actual incoming wave, whereas this spike does not appear in the PLB signal (FIG. 10B). In addition, the amplitude of the signal from the PLB (FIG. 10B) is greater than the amplitude of the signal shown in FIG. 10A corresponding to the spark acoustic emission implementation. However, in accordance with certain embodiments of the present disclosure, a spark acoustic emission device 200 includes circuitry that can increase voltage such as to increase the amplitude of the resulting signal. FIGS. 11A and 11B show the results of continuous wavelet transforms on the signals in FIG. 10A and FIG. 10B, respectively. FIGS. 12A and 12B show the respective results of Fourier transforms (FFT) in the frequency domain.

### Example 4

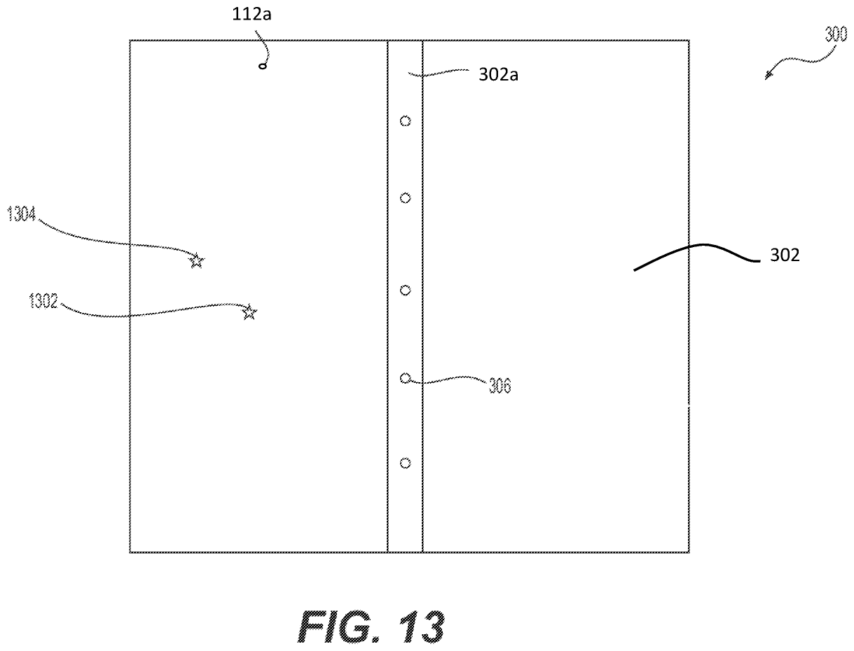

A next example implementation and discussion of corresponding results relates to simulating multiple acoustic emission events with two sparks 1302, 1304 (FIG. 13) at different locations, with a predetermined time delay from one spark discharge to the other.

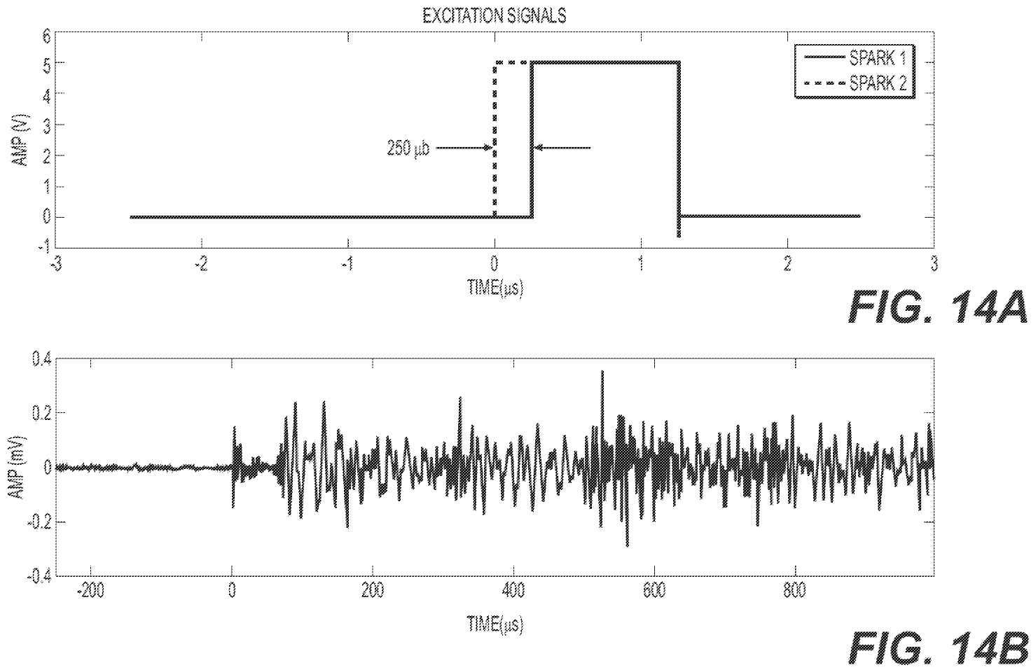

When metallic corrosion occurs (i.e., a defect), it is a process that usually does not just occur at a single point. Rather, it usually is characterized by distributed damage and occurs simultaneously at different, multiple locations. The corrosion process reduces acoustic emission in some structures. The present example relates to simulation of this natural phenomenon, to simulate multiple acoustic emission events. The diagram of FIG. 13 shows a metallic plate 302 with a central attached stiffener 302a. An AE sensor (R15a) (112a) was used, and two electrodes 202 were used for producing two sparks 1302, 1304. The sparks 1302, 1304 fired with a time delay between them of 250 microseconds. The process of the first spark 1302 firing, then the second spark 1304 firing 250 microseconds later, was repeated every one second. In accordance with some embodiments, a controller 106 coupled to electrodes 202 for producing the sparks 1302, 1304 dictates the time of firing and the time delay between firings of the two sparks 1302, 1304, as well as the time of reoccurrence. FIG. 14A shows the timing of the trigger signals (excitation signals) for the two sparks 1302, 1304. As shown, the excitation signals are separated by 250 microseconds. FIG. 14B shows the recorded acoustic emission signal for two of the sparks 1302, 1304.

### Example 5

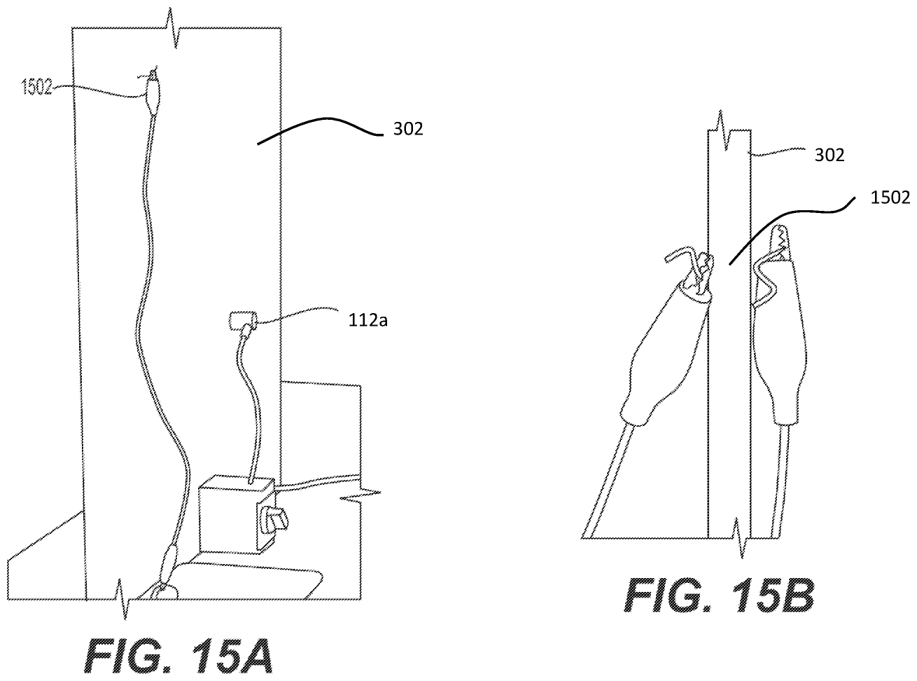

FIGS. 15A and 15B show an embodiment of a spark test on both sides of a plate 302, but using a sensor 112a on only one side of the plate 302. As shown, two electrodes 1502 are placed at the same relative location on opposing sides of an aluminum plate 302; FIG. 15B is an enlarged view of the plate 302 and electrodes 1502 on both sides of the plate 302. In this embodiment, sparks are fired by the two electrodes 1502 at the same time, at the same relative location on each side of the plate 302, to simulate symmetric guided ultrasonic modes, i.e., to excite symmetric guided ultrasonic waves.

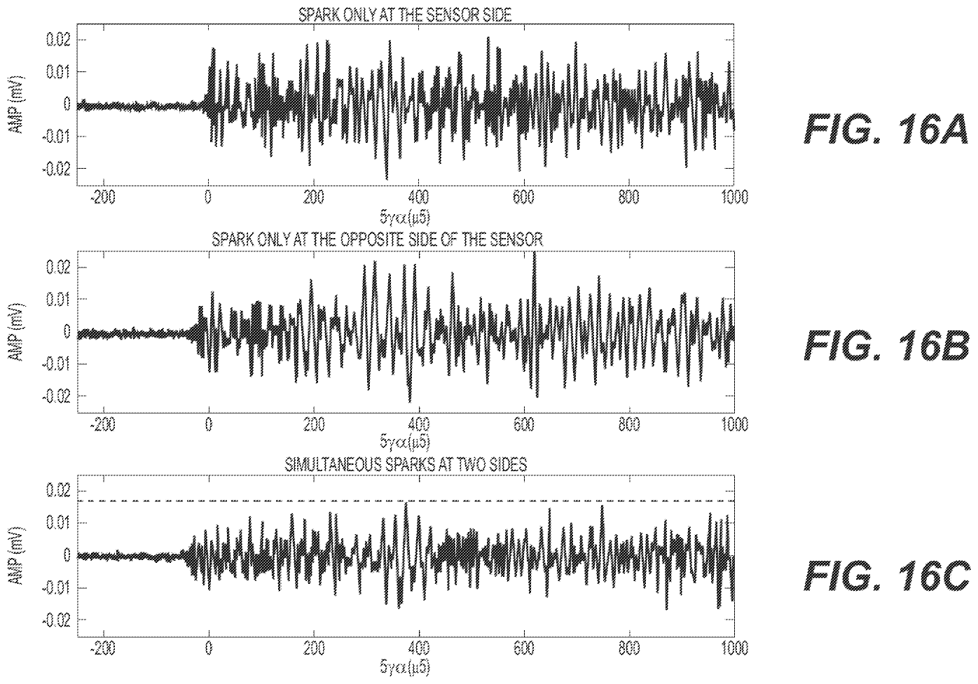

FIG. 16A shows recorded signals for an implementation in which a spark fired only on the side of the plate with the sensor 112a; FIG. 16B shows recorded signals for an implementation in which a spark 102 was fired only at the opposite side of the plate from the side having the sensor 112a; and FIG. 16C shows recorded signals for an implementation in which sparks 102 were fired at both sides at the same time. As shown in the signal in FIG. 16C, the overall amplitude is lower than that of the signal of FIG. 16A or FIG. 16B, due to a destructive influence of the two sparks 102 on each other.

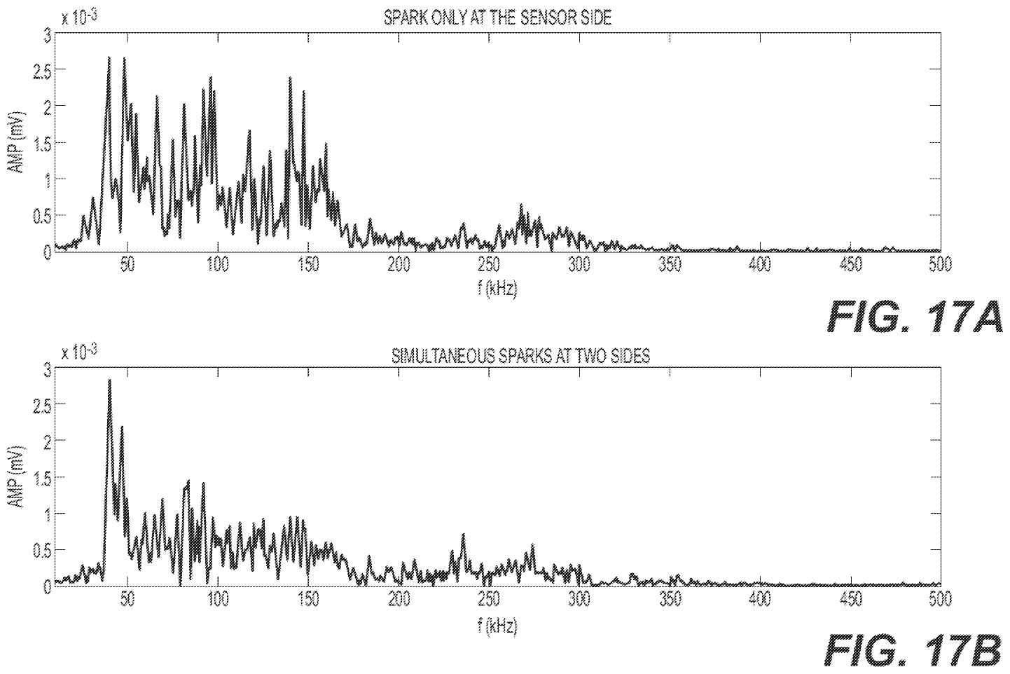

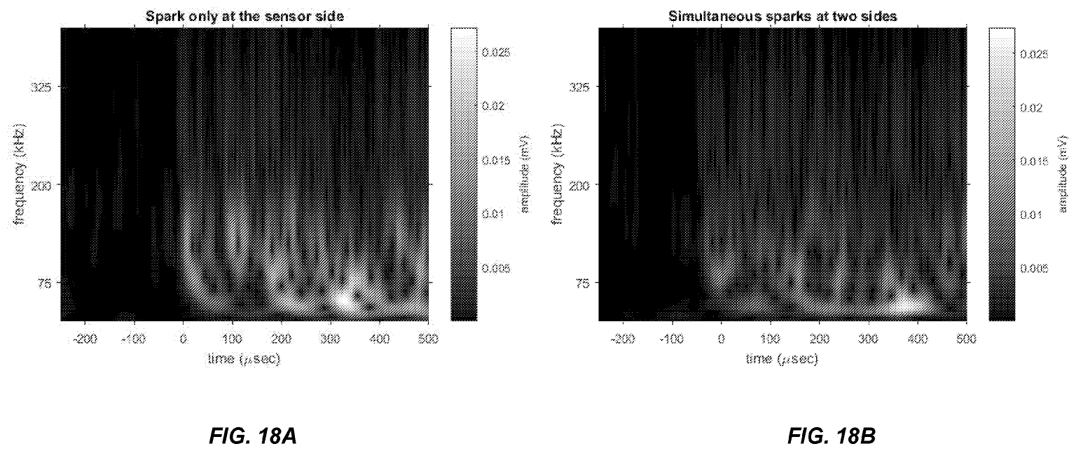

FIG. 17A shows a Fourier transform of the signal from FIG. 16A, and FIG. 17B shows a Fourier transform of the signal from FIG. 16C. As can be seen in FIG. 17B, higher frequency contents are damped. FIG. 18A shows a continuous wavelet transform of the signal in FIG. 16A (spark 102 fired only on side of the plate 302 with the sensor 112a) and FIG. 18B shows a continuous wavelet transform of the signal in FIG. 16B (sparks 102 simultaneously fired on both sides of plate 302).

### Example 6

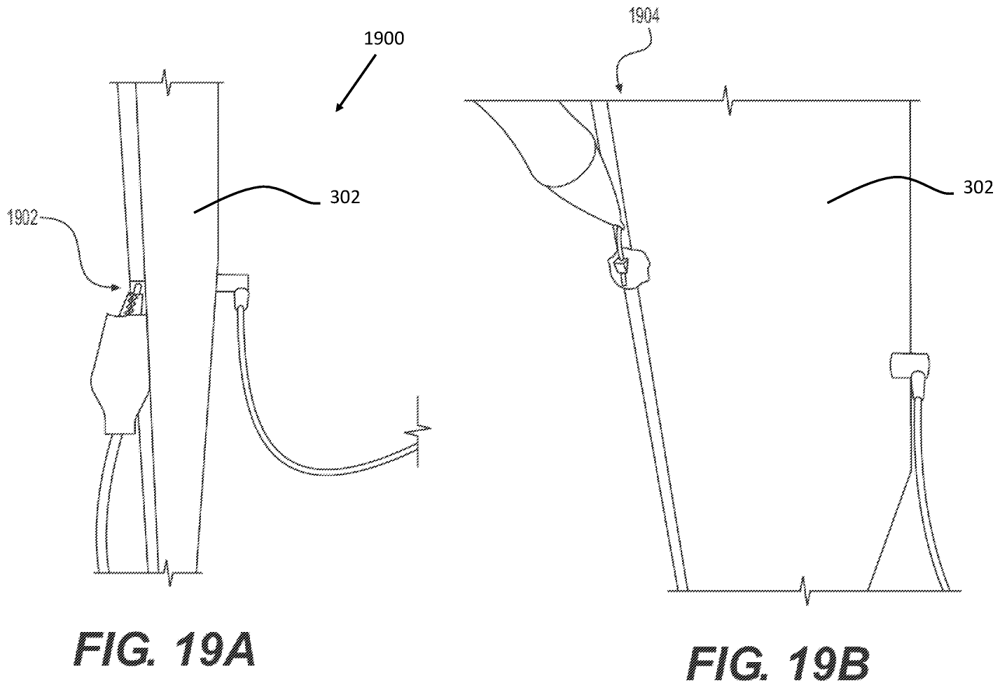

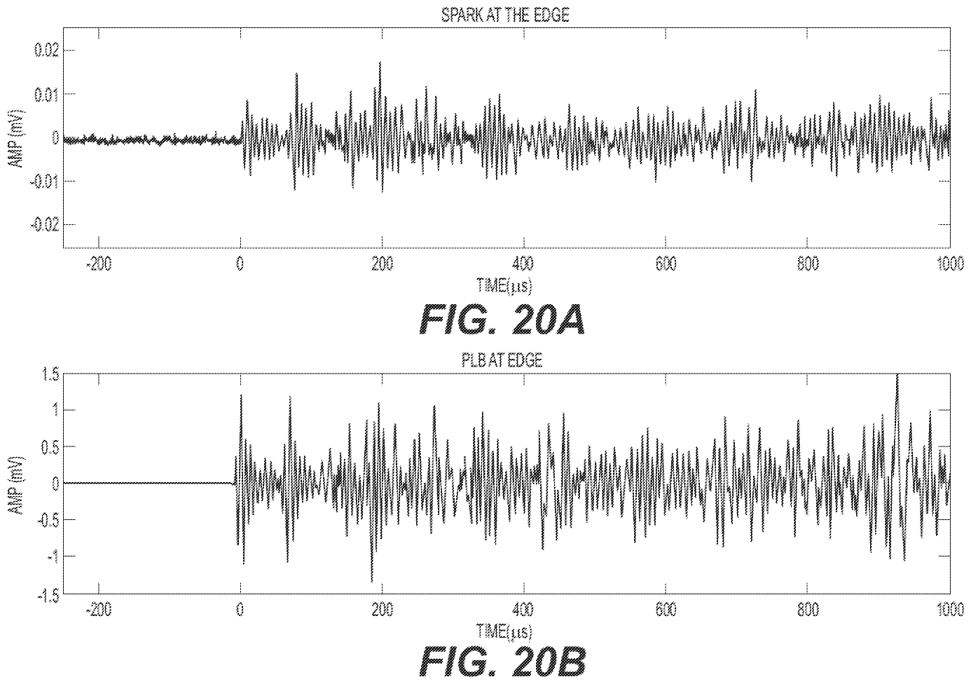

FIGS. 19A and 19B show an embodiment of a system for simulating a symmetric Lamb wave mode 1900. As shown in FIG. 19A a spark 1902 was applied at the edge of a plate 1904, and compared to a PLB (FIG. 19B) at the edge of the plate 1904. The resulting waveform signals are shown in FIG. 20A and FIG. 20B, respectively. As can be seen, the waveform patterns are comparable, but the amplitude of the signal for the PLB at the edge (see FIG. 20B) is about two orders of magnitude greater than the amplitude of the signal in FIG. 20A.

### Example 7

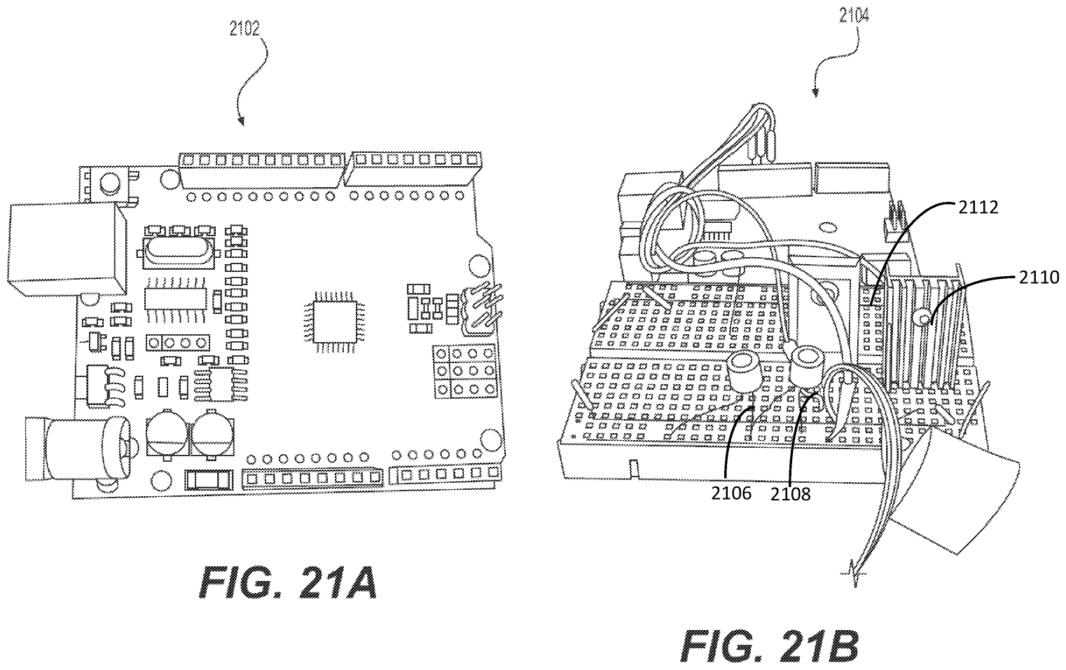

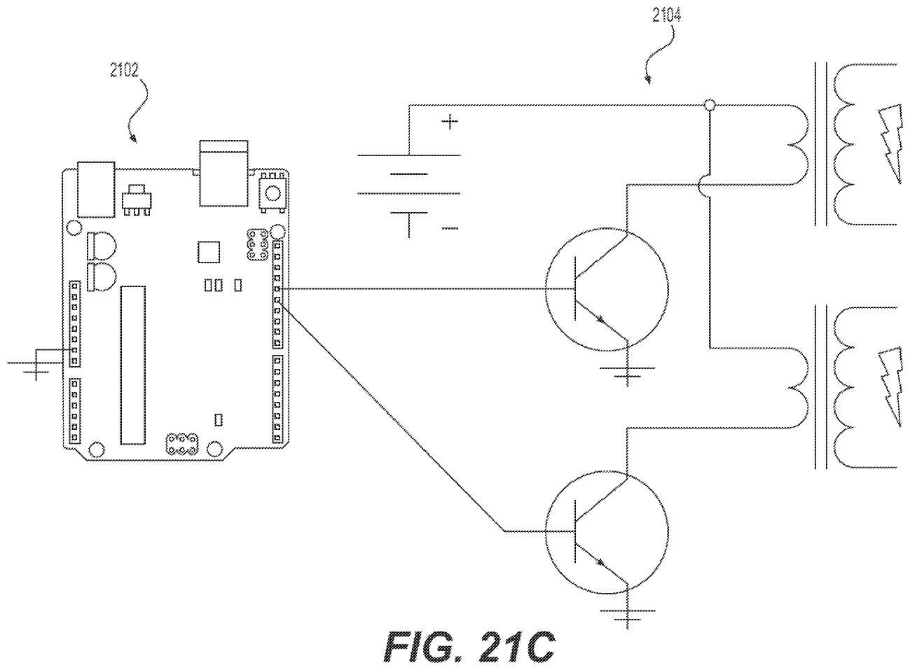

FIGS. 21A, 21B, and 21C show circuitry 2102 and electronic and electrical components 2104 for example implementations that utilize two sparks 102 as described with respect to one or more of the embodiments and examples discussed above. Specifically, FIG. 21A shows an Arduino Due microcontroller 2102, FIG. 21C shows the circuit diagram 2104, and FIG. 21B shows the implemented circuit on a breadboard 2106. The circuit 2104 uses two identical electrolytic capacitors 2108 with the capacity of 250 μF, two identical NPN transistors of type D880-Y 2110, and two identical core-type transformers 2112. The resistance of the primary and secondary winding of the transformers 2012 are 0.1Ω and 200Ω, respectively.

### Example 8

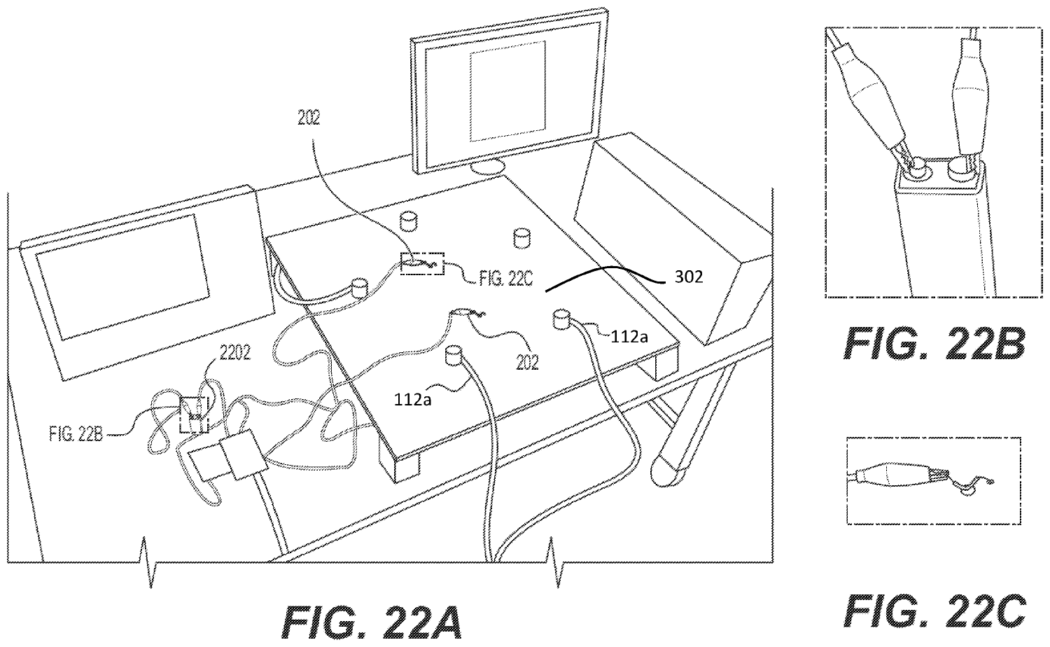

FIGS. 22A, 22B, and 22C show a system for spark acoustic emission 100 simulation in accordance with one embodiment. As shown, five acoustic emission sensors 112a (R15a with an embedded amplifier) are placed at a metallic plate 302 at separate locations around the plate 302. The system 100 is configured to, utilizing the emission sensors 112a and attached circuitry and other components shown, localize where the sparks 102 are being generated; as shown, the sparks 102 are generated by two electrodes 202 placed at different locations at the plate 302. The sparks 102 were generated at the two locations with a 50 microsecond delay between them. As shown in the configuration of FIG. 22, a single battery 2202 operates as the power source. The portable and lighter weight of such batteries 2202 allow for some embodiments of the present disclosure to be portable such that, for example, a battery-powered, portable handheld device with non-contact spark generators and non-contact sensors can be realized.

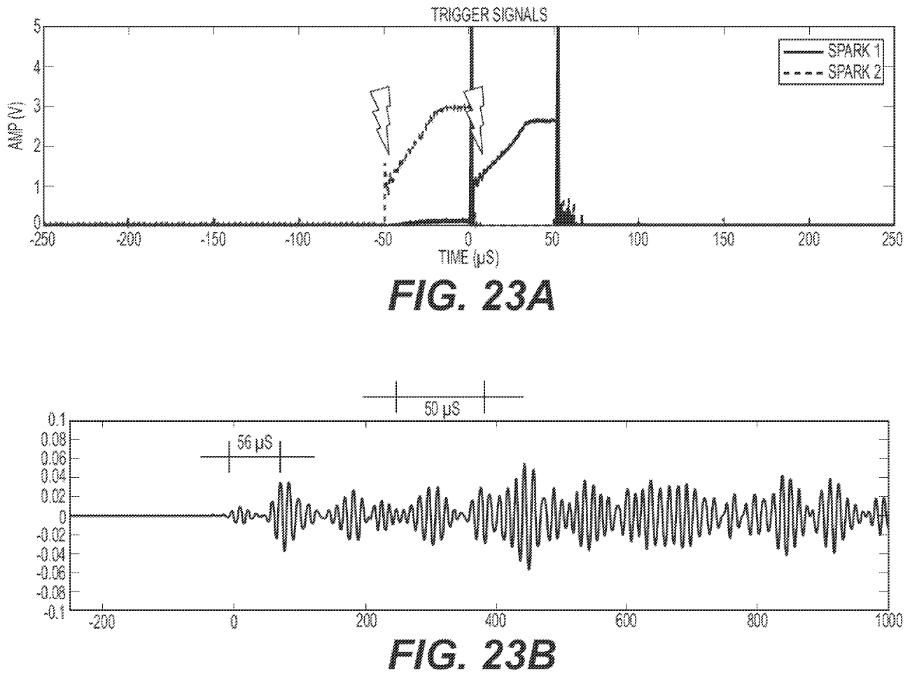

FIG. 23A shows the spark triggering signals sent to transformers for generating the sparks 102 to stimulate acoustic emission. FIG. 23B shows the recorded acoustic emission signal, which illustrates an approximately 43.8 microsecond difference between the first two arrivals. The time difference between the peak points of the two wave packets is approximately 56 microseconds.

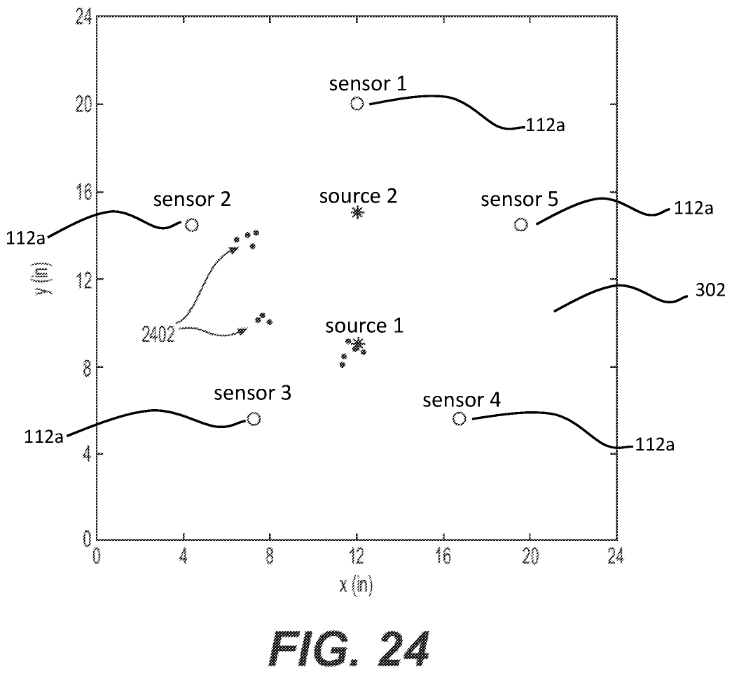

FIG. 24 illustrates results of the use of a localization algorithm referred to as a “time difference of arrival” algorithm, which uses triangulation in attempt to locate the source of the sparks 102 (i.e., locate where the sparks are being generated). The actual locations of the sources are represented by asterisk symbols (*) in the figure. The sensors 112a as shown in FIG. 22 are represented by small circles and labeled as “sensor 1”, “sensor 2”, etc. In this implementation, the time difference of arrival algorithm was unsuccessful in locating the second source (“source 2”). As reflected by the small clusters of dots that appear close to sensor 2, above sensor 3, and around source 1, the localization algorithm also mistakenly identifies what are actually artifacts 2402 to be sources.

### Example 9

In the context of ultrasonic waves, there are essentially two families of damage localization techniques, one being acoustic emission wherein sensors are passively listening to the events such as corrosion and cracking. These types of defects can be simulated by the sparks 102 in accordance with certain embodiments described herein. The second family of damage localization techniques is active ultrasonic testing, in which actuator(s) are used to generate ultrasonic waves, these waves propagate in the tested structure, and come back to a set of sensors 112.

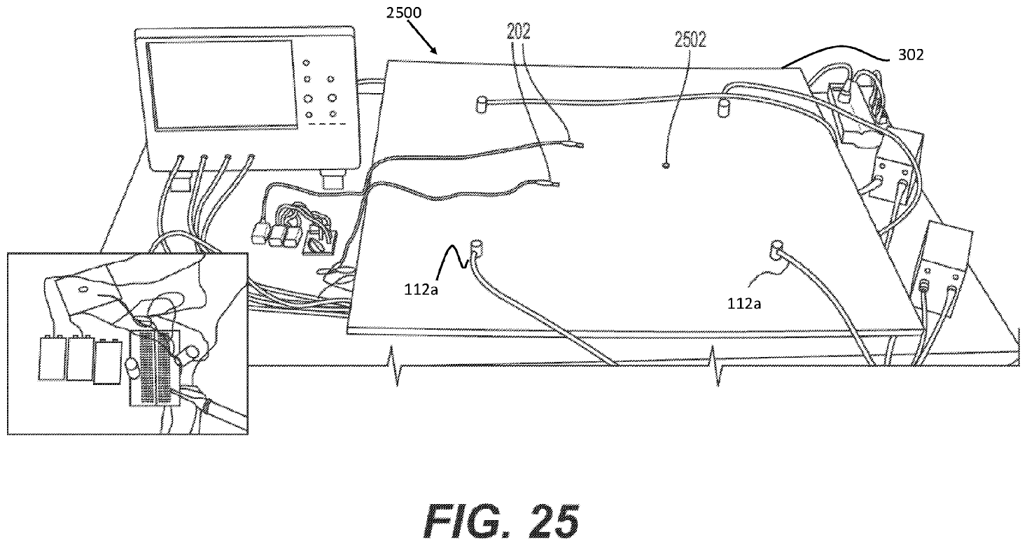

FIG. 25 shows a system 2500 for active ultrasonic testing simulation, in which four sensors 112a (listening) are placed at different locations around a metal plate 302, and two spark generators 202 serve as actuators to generate the ultrasonic waves. A defect in the structure 302 (metallic plate) was simulated using magnets 2502, with one magnet 2502 at a top of the plate and another magnet 2502 on a corresponding aligned location on the bottom side of the plate. In this embodiment, the objective of the implementation is to find the location of the magnets 2502, i.e., to effectively determine the location of a defect.

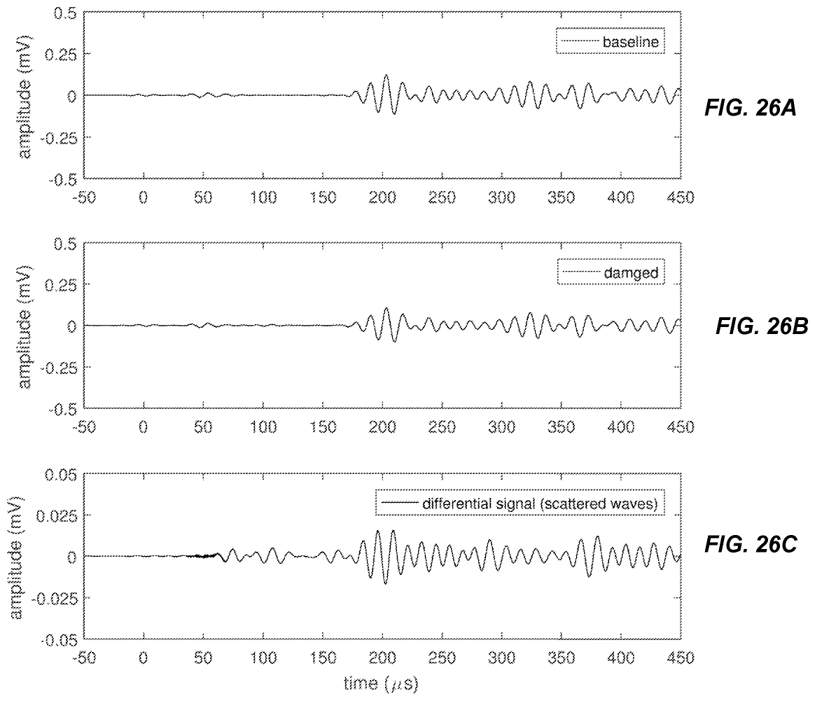

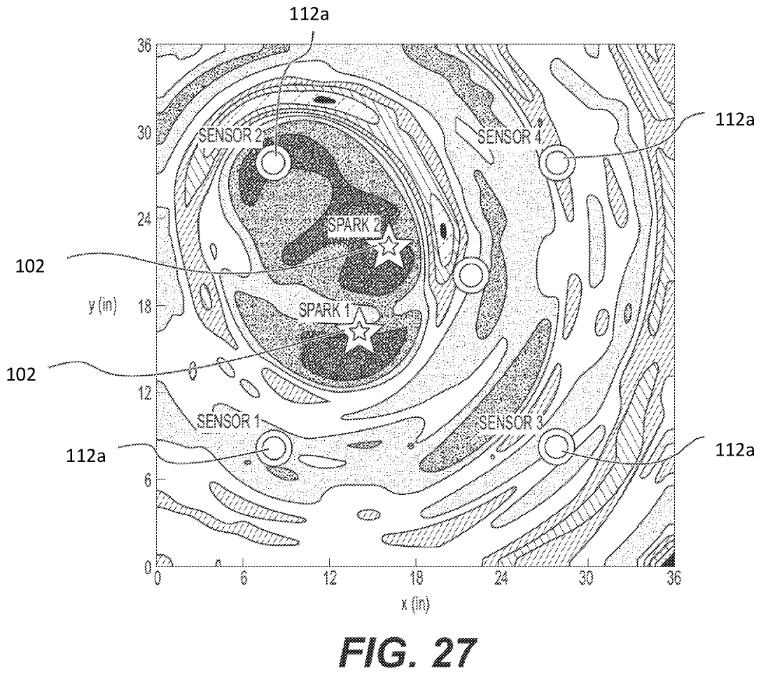

FIGS. 26A, 26B, and 26C relate to localization of the magnets 2502. Before the magnets 2502 were placed (i.e., before any damage is suspected in a structure), a set of baseline signals was obtained (by the sensors 112a) (FIG. 26A). After the magnets 2502 were placed (i.e., when damage may be suspected in a structure), another set of signals are obtained (by the sensors 112a) which reflect damage (FIG. 26B). The difference between the signal reflecting damage and the baseline signal is then calculated, which produces a “differential signal” (shown in FIG. 26C). The differential signal can be used to generate image(s) for the location of the damage, i.e., to show the location of damage. FIG. 27 shows an image obtained through the use of a delay-and-sum algorithm. It is important when analyzing the image to recognize that one should look inside the convex area covered by the sensors 112a. In the case of this setup, there were four sensors 112a (see FIG. 25), so the meaningful information is inside the area that the sensors 112a generate. There are artifacts 2402 that appear outside the convex area covered by the sensors 112a. The open circle in the image of FIG. 25 corresponds to the location of the magnet 112a, i.e., location of the damage.

### Example 10

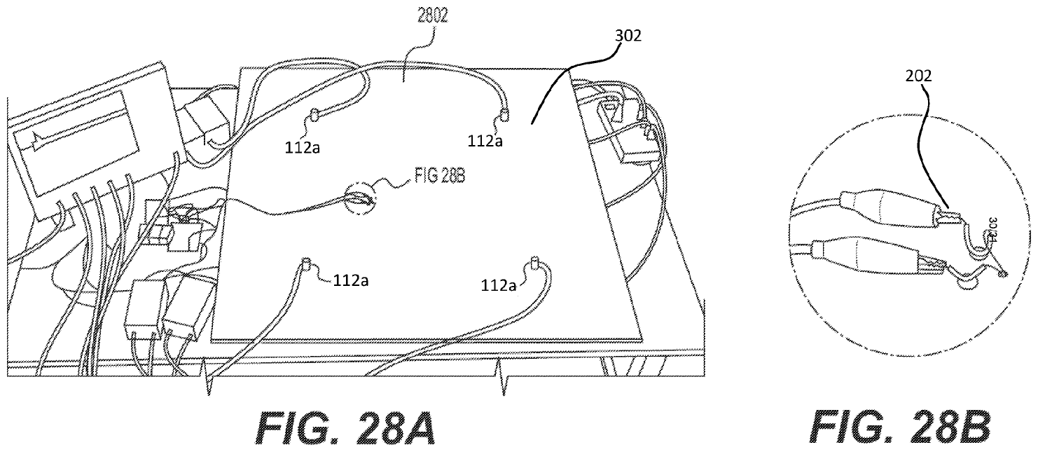

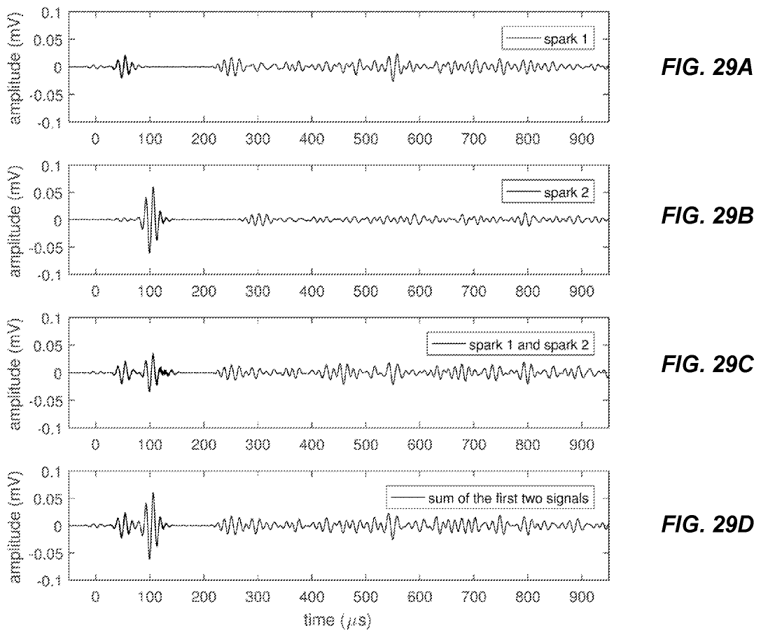

FIGS. 28A and 28B show a system for spark acoustic emission simulation 100 in accordance with another embodiment. In this configuration, two sparks 102 are generated at the same location with a time delay between each firing. As shown, the spark generators 202 (electrodes) are grouped next to one another proximate the center of a metallic plate 302, with four surrounding acoustic sensors 112a. The signals shown in FIGS. 29A, 29B, 29C, and 29D correspond to actual acoustic emission signals. The first signal (FIG. 29A) corresponds to the first spark 2102, the second signal (FIG. 29B) corresponds to the second spark 2104, the third signal (FIG. 29C) corresponds to the two sparks 2102, 2104 both firing with a 50 microsecond delay, and the fourth signal (FIG. 29D) is a summation of the first signal and second signal together.

### CONCLUSION

The various embodiments described above are provided by way of illustration only and should not be construed to limit the scope of the present disclosure. Those skilled in the art will readily recognize that various modifications and changes may be made to the present disclosure without following the example embodiments and implementations illustrated and described herein, and without departing from the spirit and scope of the disclosure and claims here appended and those which may be filed in non-provisional patent application(s). Therefore, other modifications or embodiments as may be suggested by the teachings herein are particularly reserved.

### LIST OF REFERENCES

[Dunegan H. L.] Dunegan H. L. “An Alternative to Pencil Lead Breaks for Simulation of Acoustic Emission Signal Sources.” Available online at: http://www.deci.com/report008.pdf.
[Hsu 1977] N. N. Hsu: U.S. Pat. No. 4,018,084 (1977).

1. A system, comprising:
one or more electrical spark generating components, configured to generate one or more sparks at a metallic portion of a structure, such as to stimulate the emission of at least one of acoustic and ultrasonic waves in the structure;
one or more contact or non-contact sensors configured to sense the emitted waves in the structure; and
one or more processors configured to, based on signals corresponding to the emitted waves as sensed by the sensors, determine physical characteristics of the structure.

2. The system of claim 1, wherein determining the physical characteristics of the structure comprises determining if the structure contains one or more defects.

3. The system of claim 1, further comprising a controller coupled to the one or more spark generating components and configured to control times at which the sparks are generated.

4. The system of claim 1, wherein the one or more electrical spark generating components are separated from contact with the structure.

5. The system of claim 1, wherein the one or more spark generating components comprise electrodes configured to discharge electricity to the structure to generate the one or more sparks.

6. The system of claim 2, wherein the one or more processors are configured to, based on the signals corresponding to the sensed emitted waves, determine the locations of the one or more defects.

7. The system of claim 2, wherein the one or more defects comprise corrosion or cracking.

8. The system of claim 1, wherein the electrical spark generating components are coupled to circuitry configured to select respective voltage and current for the one or more sparks.

9. The system of claim 8, wherein the circuitry is further configured such that the one or more sparks are pulsed with a high voltage and low current.

10. The system of claim 1, wherein the one or more electrical spark generating components are configured to generate a plurality of sparks simultaneously or separated by a selected time delay between about 0 and 250 microseconds.

11. The system of claim 1, wherein the one or more electrical spark generating components are placed at different locations from one another at the structure.

12-15. (canceled)

16. The system of claim 1, wherein the structure comprises a metallic plate at which the one or more sparks are generate;
wherein the metallic plate has an edge; and
wherein one or more spark generating components are placed proximate the edge and are configured to excite guided ultrasonic waves.

17. (canceled)

18. The system of claim 1, wherein the one or more sparks are generated such as to simulate one of a symmetric guided ultrasonic wave mode or an antisymmetric guided ultrasonic wave mode.

19. The system of claim 18, wherein one or more electrical spark generators are provided at symmetric locations on two opposing sides of the structure.

20. (canceled)

21. The system of claim 1, wherein the one or more processors are configured to localize acoustic emission sources using one or more sparse reconstruction functions.

22. The system of claim 1, wherein the one or more electrical spark generating components and the one or more sensors are provided in a contained portable device and the electrical spark generating components and sensors do not contact the structure when in use.

23-25. (canceled)

26. The system of claim 22, wherein the contained portable device is configured to perform nondestructive testing for a structure.

27. A method, comprising:
generating, at a structure, one or more electrical sparks configured to stimulate the emission of at least one of acoustic and ultrasonic waves in the structure;
using one or more sensors, sensing the emitted waves in the structure; and
determining, based on signals corresponding to the emitted waves as sensed by the sensors, one or more physical characteristics of the structure.

28. The method of claim 27, wherein determining the one or more physical characteristics of the structure comprises determining whether the structure contains one or more defects.

29. The method of claim 27, further comprising determining, based on the signals, the location of the one or more defects.

30-33. (canceled)

34. The method of claim 27, wherein the one or more sparks are generated by a respective plurality of electrical spark generators placed at different locations from one another at the structure.

35-41. (canceled)

42. The method of claim 27, wherein the structure comprises a metallic plate having an edge, and the method further comprises stimulating acoustic emission on the edge of the plate to excite guided ultrasonic waves.

43. The method of claim 27, wherein the one or more sparks are generated such as to simulate one of a symmetric guided ultrasonic wave mode or an antisymmetric guided ultrasonic wave mode, and
wherein simulating the symmetric guided ultrasonic wave mode comprises providing one or more electrical spark generators at symmetric locations on two opposing sides of the structure.

44-45. (canceled)

46. The method of claim 27, further comprising localizing acoustic emission sources using one or more sparse reconstruction functions.
